(19) United States
(12) Patent Application Publication
(10) Pub. No.: US 2015/0107082 A1
(43) Pub. Date: Apr. 23, 2015

(54) TOOL FOR BANDING MECHANICAL COMPONENTS AND BANDING METHOD USING SUCH A TOOL

(71) Applicant: AIRCELLE, GONFREVILLE L'ORCHER (FR)

(72) Inventors: Didier LERETOUR, MANNEVILLETTE (FR); Géraldine EUDIER, SAINT ARNOULT (FR); Christophe GUILLOU, LE HAVRE (FR)

(21) Appl. No.: 14/584,462

(22) Filed: Dec. 29, 2014

Related U.S. Application Data
(63) Continuation of application No. PCT/FR2013/051500, filed on Jun. 27, 2013.

(30) Foreign Application Priority Data
Jul. 3, 2012 (FR) 12/56346

(51) Int. Cl. B23P 11/02

(52) U.S. Cl. CPC B23P 11/025
USPC 29/447; 29/281.1; 29/525

(57) ABSTRACT

A tool for shrink-fitting mechanical parts includes a fixed portion, a movable portion movable relative to the fixed portion, a support for a part to be shrink-fitted, a docking part for docking the tool on a hoop, and an actuator displacing the movable portion when the part to be shrink-fitted is detected in a shrink-fitting position on the hoop receiving the part. In particular, the fixed portion includes a fixed jaw and a housing, and the movable portion includes a movable jaw and a housing. The support and the docking part are disposed in the corresponding housing, respectively, so that the support and the docking part determine sets of parts to be shrink-fitted and/or of hoop parts for the tool. The housings dispose on the tool the docking part and the support with geometric reference to the hoop.

### CROSS-REFERENCE TO RELATED APPLICATIONS

This application is a continuation of International Application No. PCT/FR2013/051500, filed on Jun. 27, 2013, which claims the benefit of FR 12/56346, filed on Jul. 3, 2012. The disclosures of the above applications are incorporated herein by reference.

### FIELD

The present disclosure relates to a tool for shrink-fitting mechanical parts. It also concerns a shrink-fitting method using such a tool.

### BACKGROUND

The statements in this section merely provide background information related to the present disclosure and may not constitute prior art.

Shrink-fitting is the assembly of two parts by tight fitting. The shrink-fitting operation consists of inserting a part inside a piercing or a cavity of another part. It is the case, for example, of the insertion of titanium rings in a connecting rod the piercing of which should then receive a shaft rotating or sliding on the titanium rings. The outer part is called “hoop”, the inner part is called “shrink-fit”.

In order to secure the ring on the hoop, it is known to force the ring in the piercing of the hoop. To this end, the inner diameter of the piercing is slightly smaller than the outer diameter of the ring. It is then possible to perform some kind of force-fitting of the ring in the piercing and by elastic deformation and/or by material return, the mounting is permanent.

In order to improve this shrink-fitting operation, it is also known to expand the inner diameter of the piercing and/or to shrink the inner diameter of the part to be shrink-fitted such as a ring, respectively by warming and/or by cooling.

The press-fitting or the shrink-fitting operation itself is performed in the state of the art by impacts applied by means of a mallet or a hammer. The use of the mallet or of the hammer is preceded or not by a dipping of the part to be shrink-fitted such as a ring in a liquid nitrogen vessel in order to cool it and thus reduce its outer diameter.

The drawbacks of shrink-fitting by impacts are numerous. Firstly, this shrink-fitting type is not acceptable if one of the parts, in particular the hoop, is made of a composite material such as an RTM (resin transfer molding)-type molded resin.

Shrink-fitting by impacts does not allow managing the forces applied on the part to be shrink-fitted or on the hoop. Thus, the direction and the intensity of the impacts are relatively random and they depend on the operator skill.

The part to be shrink-fitted such as a ring is placed before the first impact in an undetermined position relative to the piercing of the hoop, here again, at the mercy of the operator skill.

The ergonomics and the safety of the workstation used for the shrink-fitting by impacts applied with a mallet or a hammer are very difficult to accept.

The operator is subjected to significant risks of musculoskeletal disorders (MSDs) especially when the parts to be shrink-fitted and/or the shrink-fitting parts are heavy. These disorders are compounded by the force to be developed during the impacts and the length of the operations on a same workstation during the production of shrink-fitted parts in large series.

Finally, this results in that the operator of the workstation of the shrink-fitting by impacts applied by a mallet or a hammer should exhibit a significant musculature of the upper limbs, thus ruling out a significant number of possible operators in a given enterprise.

It has already been sought to overcome some of these drawbacks. In another state of the art represented in FIG. 1, a hoop consists of a connecting rod 7 including, to the left of the drawing, a connecting rod head provided with a receiving hole. The connecting rod 7 is deposited by the operator on a lift table 1. The work plane of the lift table 1 carries a support 10 against which the connecting rod head 8 is pressed. Opposite to the support 10, a press-fitting cylinder 5 is disposed so that its movable rod 9, optionally equipped with a press-fitting tool not visible, forces the inserting of a ring, such as a part to be shrink-fitted, in the piercing visible on the connecting rod head 8.

The shrink-fitting station is disposed in a camber 2-4. It is controlled by means of an electric box 6 and of a command accessible to the operator (not represented). Doors 2 and 3 of the camber, coupled to safeties, prohibit movement of the cylinder 5 if the doors are open, in order to improve the safety of the shrink-fitting station. Such a device reduces the force work, complying with the work ergonomics of the operator and reducing safety problems.

However, the remote use of the press-fitting cylinder makes the reference setting of the part to be shrink-fitted difficult. This results in significant production costs which are both recurrent and non-recurrent.

The ergonomics of the workstation is improved with the lift table. However, there remain manual operations which require significant forces and entail risks of falling of the heaviest parts.

It has also been found that the handling time of the different implemented parts was abnormally long in comparison with the shrink-fitting time itself.

There is also a risk of crushing and of unexpected impacts in the case where one of the part to be shrink-fitted or of the hoop is in an incorrect initial position. Particularly, if one of the parts is made of a composite material, there is a risk of delamination of the damaged part.

Similarly, the reference setting of the part to be shrink-fitted on the hoop is a dangerous step for the future of the parts. It is not possible to perform a correct and durable reference setting with the press-fitting cylinder.

Moreover, in a production workshop, the lift table occupies a significant floor area and mobilizes masses which may be very significant. These two characteristics rule out very small workshops and require significant lifting means.

Finally, in the technique of shrink-fitting with a hammer as well as in that of shrink-fitting with a press-fitting cylinder, if we use techniques of cooling and/or warming either one of the two parts, it should be noted that the shrink-fitting time should be shorter than the time of the return of the parts to temperatures at which the respective dimensions no longer allow force-fitting or force shrink-fitting.

In these two prior techniques, it is also observed that if one of the parts is made of a composite material, it may not be expanded. This results in that, since the cooling allows a limited reduction of dimensions, the application of a very significant force is forbidden.

### SUMMARY

The present disclosure provides a tool for shrink-fitting mechanical parts, remarkable in that it includes:

at least one fixed portion including a fixed jaw and at least one housing;

at least one portion movable relative to said fixed jaw including a movable jaw and at least one housing;

at least one support for a part to be shrink-fitted disposed in at least one of said housings;

at least one part for docking the tool on the hoop disposed in at least another of said housings;

said at least one support and at least one docking part being designed for determined sets of parts to be shrink-fitted and/or of hoop parts for the same tool;

said housings allowing to dispose on the tool said at least one docking part and said at least one support with geometric reference to a hoop intended to receive a part to be shrink-fitted; and
at least one actuator for displacing said at least one movable portion when the part to be shrink-fitted is detected in the shrink-fitting position on a hoop.

According to other characteristics of this shrink-fitting tool:
said at least one movable jaw cooperates with a fluid cylinder engaged by its movable rod through the hoop and said at least one part to be shrink-fitted during at least one step of press-fitting the part to be shrink-fitted on the hoop, the movable rod of the cylinder being engaged on one side of the part to be shrink-fitted and the static portion of the cylinder being integral with said at least one fixed portion;

this tool cooperates with a movable support arm;
the arm includes means for balancing the weight of the tool and means for assisted maneuver by a shrink-fitting operator.

The present disclosure also concerns a method for shrink-fitting mechanical parts by means of a tool according to the present disclosure, remarkable in that it comprises:

disposing on at least one of said jaws, said at least one docking part and said at least one support with geometric reference to at least one hoop;

mounting at least one of the parts to be shrink-fitted on a support mounted on at least one jaw of the tool;

approaching the tool to at least one hoop;

establishing the contact between the tool and at least one hoop by means of said at least one docking part with geometric reference to said at least one support; and

activating at least one actuator of the movable jaw and/or when appropriate the movable rod of a fluid cylinder disposed in relation with said at least one part to be shrink-fitted and said hoop so as to shrink-fit said at least one part to be shrink-fitted on the hoop.

According to other characteristics of the method according to the present disclosure:

this method also includes a prior step of modifying the relative dimensions of at least one of the parts before shrink-fitting, by cooling in particular by dipping in a cooling enclosure, such as a liquid nitrogen enclosure, or by heating in an oven;

this method comprises shrink-fitting a first ring in a piercing of a connecting rod head taken as a hoop, then during a second shrink-fitting, centering two locking rings on the supports of two jaws of the tool, disposing the shrink-fitting tool carrying the two locking rings relative to the connecting rod head, the jaws being placed on either side of the connecting rod head, then controlling an actuator of the tool to perform the simultaneous shrink-fitting of the two locking rings on either side of the first ring;

this method includes a step of mounting several supports of parts to be shrink-fitted and/or several parts to be shrink-fitted on the shrink-fitting tool, and a step of press-fitting the set of parts to be shrink-fitted mounted on the tool in one single activation of the actuator of the tool.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 represents a device of the state of the art which has been described above;

FIG. 2 represents a mounting diagram of various parts to be shrink-fitted on a hoop;

FIG. 3 represents a schematic top view of one form of a shrink-fitting tool according to the present disclosure;

FIG. 4 represents a perspective view of the form of the tool of FIG. 3;

FIGS. 5A to 5C represent various steps of another form of a shrink-fitting method according to the present disclosure;

FIGS. 6A to 6C represent various steps of other form of a shrink-fitting method according to the present disclosure;

FIGS. 7A to 7C represent various steps of another form of a shrink-fitting method according to the present disclosure; and

FIG. 8 represents another form of a shrink-fitting tool according to the present disclosure.

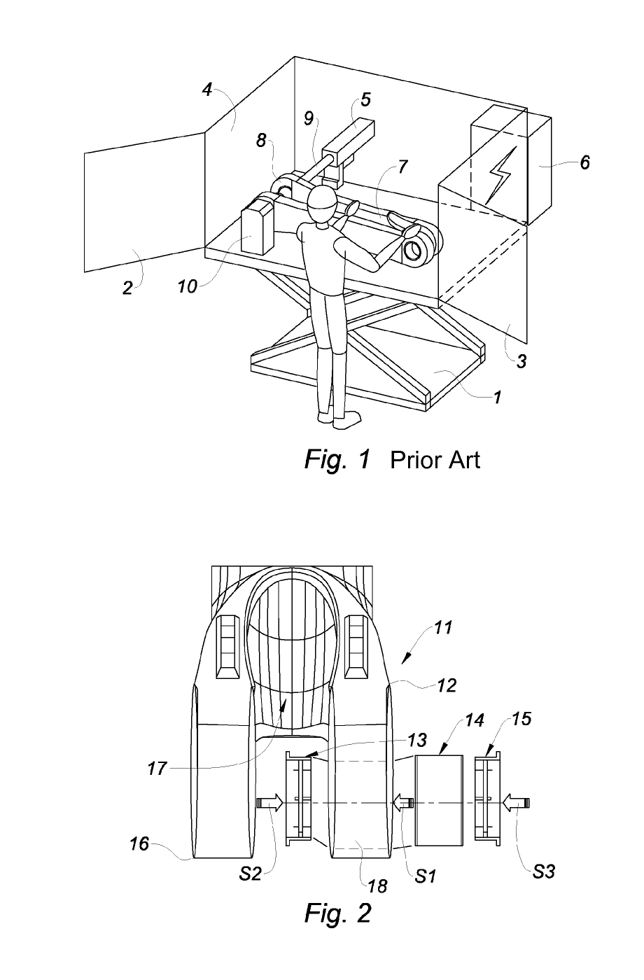

### The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In FIG. 2, there is represented a mounting diagram of various parts to be shrink-fitted on a hoop. The hoop here consists of an aviation connecting rod intended to support a portion such as the nacelle of a turbojet engine on the pylon of an aircraft. Such a part is typically made of a composite material based on a mold-injected resin. It exhibits at least one connecting rod head provided with a piercing allowing the passage of a shaft for fixing the connecting rod to a support and/or to a load.

In particular, since the connecting rod is made of a composite material, the shaft should be able to be displaced in a friction part such as a titanium ring. Thus, the shrink-fitting of the friction ring in the connecting rod head should be performed.

The connecting rod 17 made of a composite material exhibits at one of its ends a connecting rod head composed of two fingers 16 and 12. Each finger of the connecting rod head is provided with a hole 18 in the finger 12. Only the shrink-fitting is described on the finger 12. The hole 18 should be occupied by three rings: a central titanium ring 14 surrounded by two bronze locking rings 13 and 15.

In the state of the art, the shrink-fitting of the first ring or central ring 14 is first performed during a step S1 by force-inserting, for example the technique of the hammer or of the press-fitting cylinder, the ring 14 in the hole 18. Then, the shrink-fitting of the locking ring 13 is performed during a step S2 with the same technique. Finally, the shrink-fitting of the locking ring 15 is performed during a step S3 with the same technique.

The shrink-fitting method which uses the shrink-fitting tool of the present disclosure limits the three operations S1 to S3 that we are compelled to execute according to the state of the art only to two shrink-fitting operations, as will be described later.

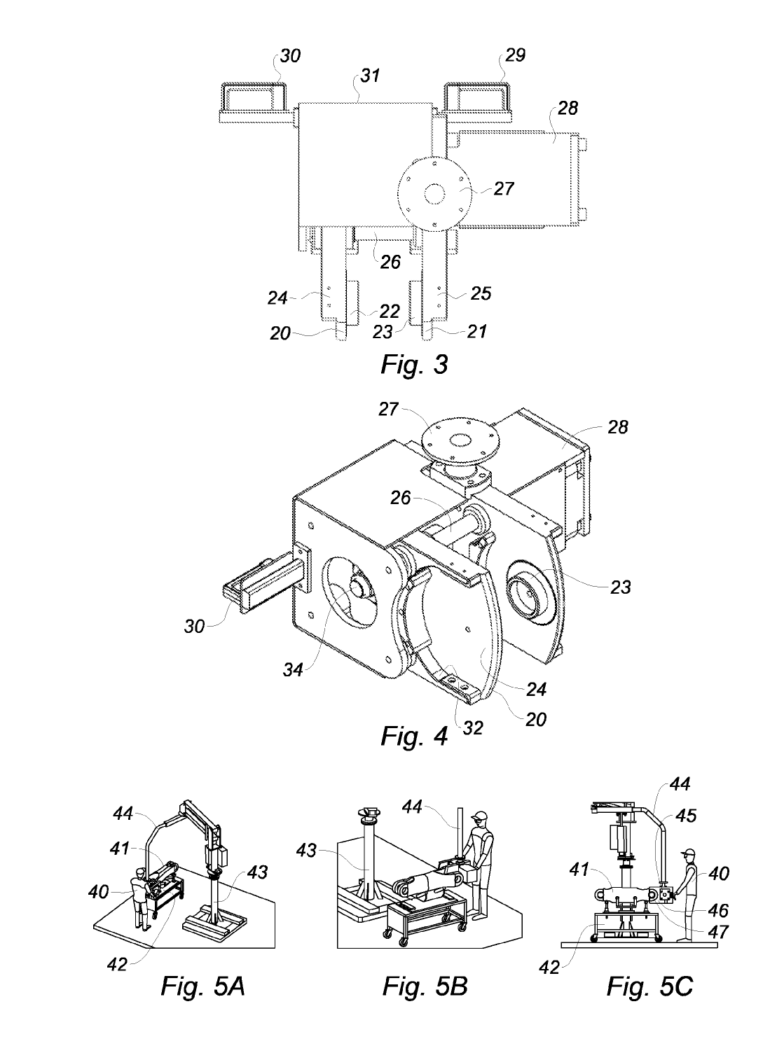

In FIG. 3, there is represented a schematic top view of one form of a shrink-fitting tool according to the present disclosure.

The shrink-fitting tool includes a fixed portion 21, 28, 31 and a movable portion 20, 22, 24. The fixed portion exhibits a fixing platen 27 at the end of a manipulator arm (not represented) which will be described later. It is provided with gripping and/or manipulation means including two ergonomic handles 29, 30. The movable portion 20 exhibits the shape of a jaw or an elongated plate which is driven in translation along a direction perpendicular to its location plane by means of an actuator 28. In the form of FIG. 3, the actuator 28 of the movable jaw 20 is an actuating cylinder which includes an electric motor 28 which drives, as it will be seen later, a screw which penetrates in a nut (not represented) integral with the movable jaw or plate 20. Thus, by controlling the rotational direction of the motor 28, the operator may approach or move away the movable jaw 20 to the opposite fixed portion which includes a fixed plate or jaw 21.

In other forms, the actuating cylinder of the movable jaw 20 is a pneumatic cylinder the stator of which is integral with the fixed portion of the tool and the free end of the rod is integral with the movable jaw.

In another form, the actuating cylinder is disposed between two movable jaws so that the latter may, at the operator's command, approach to each other or move away from each other, as it will be described later. In this case, one of the movable jaws acts as a fixed portion for the other movable jaw, the fixed and movable natures being relative.

In FIG. 4, there is represented a perspective view of the form of the tool of FIG. 3. In FIGS. 3 and 4, the same elements of the shrink-fitting tool bear the same reference numerals and are described with either Figures.

The fixed portion of the shrink-fitting tool is contained in a casing the front face of which is open in order to let the free end of each one of the two jaws 20 and 21 pass. Extending over the width between the two jaws, there are disposed columns such as the column 26 which allows performing a guiding of the relative movements of approaching and moving away of the two jaws 20 and 21.

The driving cylinder 34 as it has been described includes a worm screw the tip of which is visible through an opening of the casing. Thus, the movable jaw 20 may be displaced perpendicularly to its location plane along the screw and the columns such as the column 26 which prevent its rotation and compel it to remain parallel to itself during relative movements of the two jaws 20 and 21 during a shrink-fitting.

The shrink-fitting tool then includes means 22, 23 for centering and fixing parts to be shrink-fitted on one of or both of the jaws 20 and 21, and on one of or both of the faces of these jaws. For this purpose, the means for centering and fixing the parts to be shrink-fitted comprises a support for a part to be shrink-fitted. Such a support 22, 23 cooperates with means for relative positioning of the part to be shrink-fitted relative to the position reference on the hoop.

In one form, the support for the part to be shrink-fitted comprises a cylindrical tube which is intended to carry a ring such as the rings 13-15 (FIG. 2). The position of the cylindrical tube is referenced relative to another point of each jaw, thus allowing the operator to dispose the shrink-fitting tool in a guaranteed shrink-fitting position relative to the hoop.

For this purpose, the shrink-fitting tool also includes a bearing portion on the hoop so as to determine a reference position of the tool in the shrink-fitting position. This bearing portion is in the form of FIGS. 3 and 4, made by means of docking parts 24, 25 which are mounted on one of or both of the jaws 20 and 21. The arrangement of a docking part on the shrink-fitting tool is provided so as to position the part(s) to be shrink-fitted relative to a docking reference of the hoop. A docking part may be disposed in a removable manner in a housing on either one of the jaws. Each docking part such as the part 24, exhibits a profile 32 adapted to bear on a bearing or docking surface on the hoop. Each docking part is hence profiled depending on the hoop to which it is intended. Thus, the reuse of the shrink-fitting tool is provided for a range of hoops which does not limit the use of the shrink-fitting tool of the present disclosure only to the given example of a connecting rod described in FIG. 2.

This results in that the support 22, 23 for a part to be shrink-fitted cooperates with means for relative positioning of the part to be shrink-fitted relative to a docking reference of the hoop. Once the docking is executed, it is then possible for the operator to activate the cylinder 34 which has the effect of approaching the movable jaw 20 to the fixed jaw 21 and thus press-fitting without force and in a precise manner the part(s) to be shrink-fitted on the hoop on either side of which the movable 20 and fixed 21 jaws have been disposed beforehand.

In one form, the fixed jaw 21 comprises a fixed station or a bearing allowing to exert the shrink-fitting force on the hoop and on the part to be shrink-fitted when the movable jaw 20 is driven in movement of approaching to the fixed jaw 21.

In FIGS. 5A to 5C, there are represented various steps of one form of a shrink-fitting method according to the present disclosure in which a particular form of a shrink-fitting tool according to the present disclosure is used. In FIGS. 5A to 5C, the same elements bear the same reference numerals.

The operator 40 has beforehand disposed the hoop, here an aviation connecting rod 41 on a support 42. A manipulator arm 43 includes an end portion 44 on which the shrink-fitting tool 45 is fixed by its platen (see 27, FIG. 3). In a position spaced from the support 42 (not represented), the operator loads at least one part to be shrink-fitted on the shrink-fitting tool 45. He grasps the shrink-fitting tool by his handles (see 29, 30 in FIGS. 2 and 3) and with a minimal force, displaces the shrink-fitting tool with the part(s) to be shrink-fitted toward the hoop 41 on the support 42.

In one form, the manipulator arm 43 includes means for balancing and/or assisting the operator while driving the load of the arm, here consisting of the shrink-fitting tool equipped with one or several parts to be shrink-fitted. Examples of such an arm are commercially available such as the manipulator arms of Dalmec company.

The head 47 of the connecting rod 41 exhibits a determined and known profile. The shrink-fitting tool 45 is thus equipped with at least one docking part 46 which provides a determined guiding of the shrink-fitting tool 45 when the operator 40 approaches it to the connecting rod head 47.

When the contact is established, the operator 40 controls the activation of the driving cylinder (see 28, 34 in FIGS. 2 and 3) so that during the movement of approaching of the movable jaw carrying a part to be shrink-fitted, the part to be shrink-fitted engages in the provided hole of the hoop 41.

This method of shrink-fitting by means of the shrink-fitting tool of the present disclosure provides the following results.

The method of the present disclosure provides an auto-centering of the parts to be shrink-fitted such as the rings at the time of shrink-fitting. It allows limiting the risks of delamination of the composite when the hoop is made of a composite material. It avoids any stressing of the hoop and allows suppressing the impacts caused during the press-fitting with the hammer.

The method of the present disclosure is executed without manipulating the part to be shrink-fitted during the operations at the station but it is provided by displacements of the shrink-fitting tool around the hoop by means of the manipulator arm. This results in an actual weight of the shrink-fitting tool which may be limited for example to 1 kg. This results in limiting risks of MSDs (musculoskeletal disorders), thus providing compliance with rules of hygiene and ergonomics. Thanks to the method of the present disclosure, the recurrent and non-recurrent costs are under control.

Moreover, the shrink-fitting method allows adapting the shrink-fitting tool to all the references of parts to be shrink-fitted such as rings to be mounted.

Thus, it becomes possible to provide compliance with the authorized maximum shrink-fitting time between the time the ring is released out of nitrogen and the beginning of the shrink-fitting phase.

Finally, the method of the present disclosure allows managing the press-fitting force by controlling the force of the cylinder, for example by limiting its motor torque in case of blockage during the press-fitting by means of an automation within the reach of the one skilled in the art.

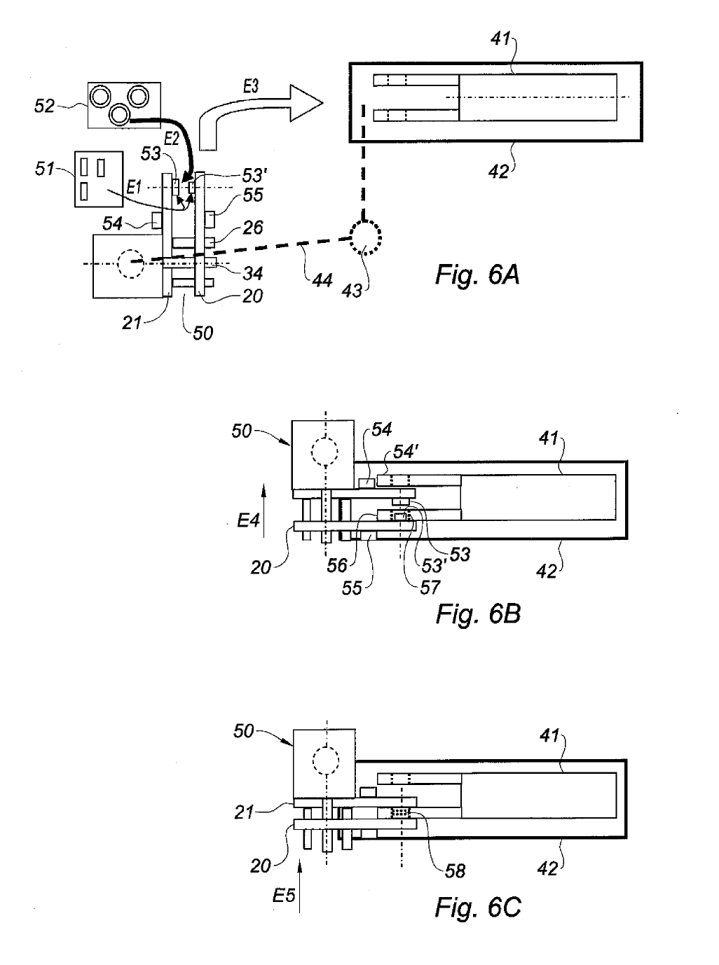

In FIGS. 6A to 6C, there are represented various steps of one form of a shrink-fitting method according to the present disclosure. In these figures, the elements common to those of FIGS. 5A to 5C have been taken up with the same reference numerals. Moreover, a schematic representation of the shrink-fitting tool defined in FIGS. 3 and 4 has been taken up under the reference numeral 50. Particularly, the method of the present disclosure has been applied to the shrink-fitting of an aviation connecting rod with the three rings described in FIG. 2.

In FIG. 6A, there is represented the arrangement of the means used in one form of the method of the present disclosure. In FIG. 6A, the method is in a state before the beginning of the operation of shrink-fitting itself. Two docking parts 54 and 55 have been disposed on housings positionally referenced on the fixed 21 and movable 20 jaws. These docking parts are easily dismountable so as to allow processing a predetermined range of parts to be shrink-fitted and of hoops with the same tool.

Supports providing the position referencing, and the centering of a part to be shrink-fitted are disposed in a reserve 51. During a step E1, the operator picks up a support 53 to mount it in the housing provided for this purpose on the inner face of the fixed jaw 20 relative to the movable jaw 21. Although the other jaw or fixed portion should not carry a second part to be shrink-fitted at this step of the method, the operator, during the step E1, also disposes a support 53′ in front of the support 53. To help in centering during the press-fitting, the support 53′ is profiled so as to cooperate with a portion of the part to be shrink-fitted which is mounted on the facing support 53 as will be explained later. The unused support 53′ here cooperates with means for centering and supporting the part to be shrink-fitted.

A reserve 52 of parts to be shrink-fitted, here titanium rings and bronze locking rings as explained in FIG. 2, keeps them cooling in liquid nitrogen. During a step E2, the operator mounts a cooled ring on the centering support 53, the reference numeral 53 in the drawing referring both to the titanium ring as the part to be shrink-fitted, its support 53 facing the support 53′ cooperating with means for supporting and centering the part to be shrink-fitted and the association of the part to be shrink-fitted, here a titanium ring, and its support.

The shrink-fitting time is then constrained by the warming duration of the cooled ring.

During a step E3, the operator then displaces the shrink-fitting tool 50 carrying the ring to be shrink-fitted toward the hoop 41 disposed on its support 42 by using the manipulator arm 43, 44.

In FIG. 6B, the shrink-fitting tool 50 has been disposed on the hoop 41 by using the docking part 54 which comes into contact on a shrink-fitting positioning reference surface 55′ of the shrink-fitting tool 50 on the hoop 41. During this step E4, the ring to be shrink-fitted on its auto-centering support 53 is correctly aligned, thanks to the docking part 54 in front of the hole 57 on the finger 56 of the connecting rod head, in order to be shrink-fitted. At the same time, the support 53′ has been introduced in the hole 57 of the hoop, here the connecting rod 41. As indicated above, the portion of the support 53′ facing the support 53 carrying the ring to be shrink-fitted is profiled so as to be engaged in a portion of the ring when the latter will be press-fitted in the hole 57. This portion of the part to be shrink-fitted preferably consists of the bore (not represented) of the titanium ring on its support 53. The support 53 penetrates through one side of the bore of the ring to be shrink-fitted, but preserves the other end of the bore free by a determined length of the support 53 smaller than the thickness of the ring to be shrink-fitted. This results in that a determined thickness is preserved in the bore of the ring to be shrink-fitted supported by the support 53 in order to receive the guiding of the support 53′ during the press-fitting itself of the ring in the hole 57 of the connecting rod head. Thus, centering or guiding of the part to be shrink-fitted during the press-fitting is provided.

In FIG. 6C, during a step E5, the operator 50 has activated the cylinder for driving the movable jaw 21 relative to the fixed jaw 20, so that the ring 58 is finally correctly shrink-fitted in the hole 57. For convenience, the two supports 53 and 53′ on the fixed 20 and movable 21 portions have not been represented.

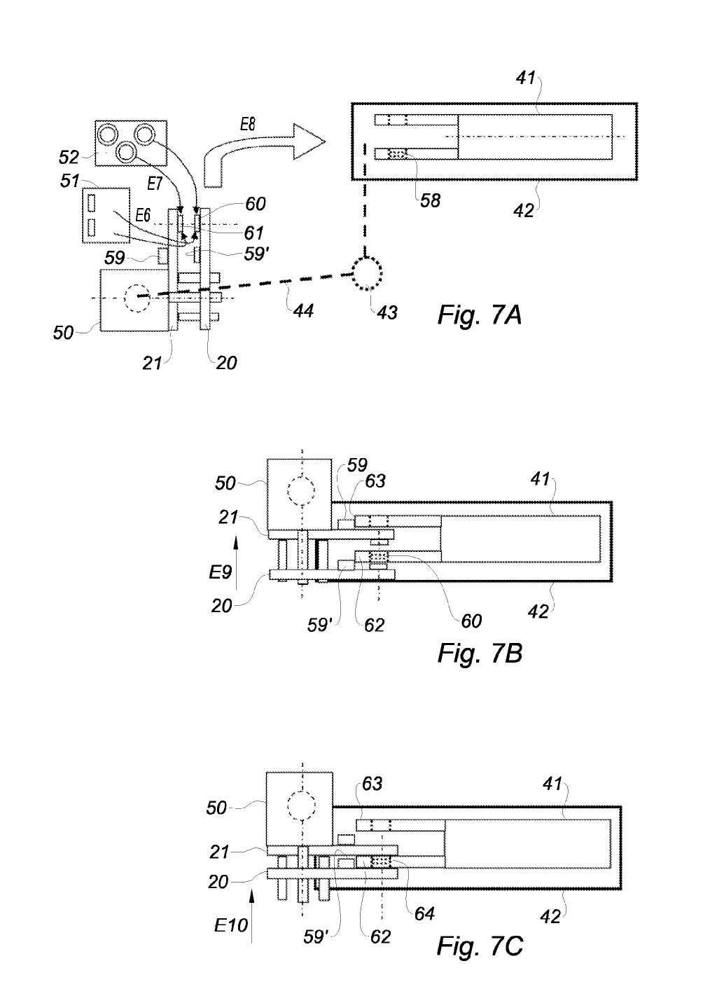

In FIGS. 7A to 7C, there are represented various steps of a shrink-fitting method according to the present disclosure. In these figures, the elements common to those of FIGS. 6A to 6C have been taken up with the same reference numerals.

In the described example, the method performed and described using FIGS. 6A to 6C continues here. The operator has brought the shrink-fitting tool 50 back toward the station containing the locking rings which should now be shrink-fitted over the already shrink-fitted ring 58 (FIG. 6C). After having removed the shrink-fitting tool 50 from its auto-centering support 53 (FIG. 6A), the operator disposes docking parts 59 and 59′ on housings provided to this end on the fixed 20 and movable 21 jaws.

Then, the operator, during a step E6, selects from the reserve of supports of parts to be shrink-fitted 51, two auto-centering supports 60 and 61 on each one of the fixed 20 and movable 21 jaws, facing each other.

During a step E7, the operator disposes two bronze locking rings (of the rings 13 and 15 kind, FIG. 2) on their auto-centering support 60 and 61 after having extracted them from their reserve of cold 52 in order to reduce their outer diameter and facilitate their insertion on the hoop 41.

During a step E8 identical to the preceding step E3, the operator approaches the shrink-fitting tool 50 equipped with the locking rings to the hoop on the connecting rod 41.

In FIG. 7B, there is represented the state E9 in which the shrink-fitting tool 50 carrying the two rings to be shrink-fitted on each one of the fixed 20 and movable 21 jaws. The jaws are placed, as before (FIG. 6B), on either side of the finger of the connecting rod head which has already received the ring 58 shrink-fitted in the hole 57 (FIG. 6B). To place the shrink-fitting tool in a correct shrink-fitting position, the operator applies the docking parts 59 and 59′ on corresponding portions on the ends 62 and 63 of the fingers composing the connecting rod head of the connecting rod 41.

In FIG. 7C, during a step E10, the operator, having assessed the correct alignment and positioning of the locking rings on the shrink-fitting tool 50 relative to the hole in which the ring 58 has been precedingly shrink-fitted, activates the cylinder for driving the movable jaw 21 on the fixed jaw 20 so that the two locking rings are shrink-fitted on either side of the ring 58 to form a shrink-fitted set 64.

The same two-step shrink-fitting operation, respectively in FIGS. 6A to 6C, then in FIGS. 7A to 7C, is reproduced on the second finger of the connecting rod head.

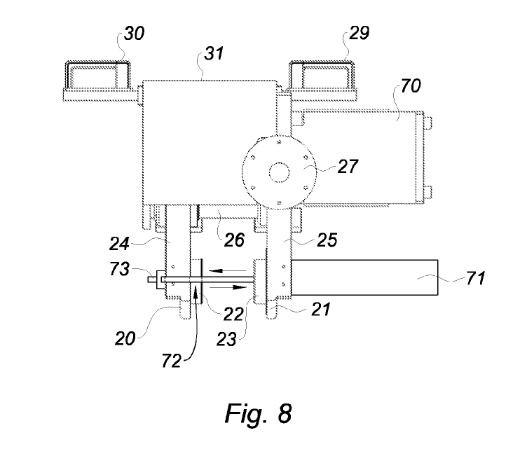

In FIG. 8, there is represented another form of a shrink-fitting tool according to the present disclosure. In FIG. 8, a fluid power plant 70 cooperates with a fluid cylinder 70 disposed at the free end of the fixed 21 and movable 20 portions of the tool. This arrangement allows applying more significant forces and avoiding or limiting the cantilever effect when the shrink-fitting force is applied by the single electric cylinder 28 of the form of the preceding figures.

In one form, the fluid power plant 70 applies a first motive force by means of a first cylinder (not visible in FIG. 8) but the movable rod of which is similar to and acts like the worm screw 34 of the preceding form. A second cylinder 71, fed by the fluid power plant 70 by means of flexible hoses not represented, exhibits a movable rod 72 which passes through the fixed 21 and movable 20 portions or jaws . The body of the cylinder 71 bears on the outer face of the fixed portion 21 while the free end of the movable rod 72 of the cylinder is provided with a thread receiving a quarter-turn nut 73 which allows the cylinder rod 72 to bear on the outer face of the movable 20 portion or jaw.

According to another form, the first cylinder actuated by the fluid power plant 70 (such as 34 in FIGS. 3 and 4) operates to dispose the jaws 20 and 21 in the shrink-fitting position on the hoop. Then, only the second cylinder 71, once disposed, operates for the press-fitting. Otherwise, the first and second cylinders cooperate during the press-fitting.

The shrink-fitting method of the present disclosure is then modified as follows. The shrink-fitting tool receives supports of parts to be shrink-fitted such as taught above. The auto-centering supports are only pierced with a bore to let the movable rod of the cylinder pass. Then, the shrink-fitting tool receives the part(s) to be shrink-fitted and it is approached in the shrink-fitting position on the hoop. The shrink-fitting method is then modified.

The operator disposes (the arrow to the left, FIG. 8) the second cylinder 71 bearing on the outer faces of the fixed 21 and movable 20 portions. He passes the movable rod 72 of the second cylinder 70 through the openings of the shrink-fitting tool, the parts to be shrink-fitted which are mounted therein, and of the bore on the hoop on which the part(s) to be shrink-fitted should be press-fitted. Finally, he locks the quarter-turn nut 73 on the free tip of the movable rod 72 of the cylinder 71. The entering pressure of the movable rod 72 is then controlled (the arrow to the right, FIG. 8) on the pressure power plant 70 and the movable rod 72 enters inside the body of the cylinder 71. This results in an approaching of the movable portion 20 on the fixed portion 21 and a press-fitting of the part to be shrink-fitted on the hoop.

Thus, the method of the present disclosure has the following advantages. It provides control over the shrink-fitting time limited by the time for the liquid nitrogen cooled rings to return to room temperature. It allows limiting risks to which the human operator and the equipment are exposed. The shrink-fitting station is open to all operators without selection criteria (height, musculature, gender).

Moreover, the investments for producing the shrink-fitting tool and implanting it in the production workshop are low. The method offers a control over the recurrent production costs and avoids the use of consumables.

Moreover, the method of the present disclosure allows readapting at low cost the shrink-fitting tool for other productions concerning other parts to be shrink-fitted and other hoops.

What is claimed is:

1. A tool for shrink-fitting mechanical parts, comprising:
at least one fixed portion comprising a fixed jaw and at least one housing;
at least one movable portion comprising a movable jaw and at least one housing, said movable portion being movable relative to said fixed jaw;
at least one support for a part to be shrink-fitted, said support disposed in at least one of said housings;
at least one docking part for docking the tool on a hoop, said docking part disposed in at least another of said housings;
said at least one support and said at least one docking part configured to determine sets of parts to be shrink-fitted and/or of hoop parts for the tool;
said housings configured to dispose on the tool said at least one docking part and said at least one support with geometric reference to the hoop receiving the part to be shrink-fitted; and
at least one actuator displacing said at least one movable portion when the part to be shrink-fitted is detected in a shrink-fitting position on the hoop.

2. The tool according to claim 1, wherein said movable jaw cooperates with a fluid cylinder engaged by a movable rod thereof through the hoop and the part to be shrink-fitted during at least one step of press-fitting the part to be shrink-fitted on the hoop, the movable rod of the fluid cylinder being engaged on one side of the part to be shrink-fitted and a static portion of the fluid cylinder being integral with said at least one fixed portion.

3. The tool according to claim 1, wherein the tool cooperates with a movable support arm.

4. The tool according to claim 3, wherein the movable support arm comprises means for balancing a weight of the tool and means for assisting maneuver by an operator.

5. A method for shrink-fitting mechanical parts by means of the tool according to claim 1, the method comprising the following steps:
disposing on at least one of said jaws, said at least one docking part and said at least one support with the geometric reference to the hoop;
mounting the part to be shrink-fitted on said at least one support mounted on at least one of said jaws of the tool;
approaching the tool to the hoop;
establishing a contact between the tool and the hoop by said at least one docking part with geometric reference to said at least one support; and
activating said at least one actuator disposed in relation with said the part to be shrink-fitted and the hoop, so as to perform shrink-fitting the part to be shrink-fitted on the hoop.

6. The method according to claim 5, further comprising a prior step of modifying relative dimensions of the part before shrink-fitting, by dipping in a cooling enclosure.

7. The method according to claim 6, wherein the cooling enclosure is a liquid nitrogen enclosure.

8. The method according to claim 6, the prior step comprises heating the part in an oven to modify dimensions of the part before shrink-fitting.

9. The method according to claim 5, wherein the method further comprises:
shrink-fitting a first ring in a piercing of a connecting rod head which is taken as the hoop;
during a second shrink-fitting, centering two locking rings on the supports of two jaws of the tool, and disposing the tool carrying the two locking rings relative to the connecting rod head; and
placing the jaws on either side of the connecting rod head, and then controlling the actuator of the tool to perform simultaneous shrink-fitting of the two locking rings on either side of the first ring.

10. The method according to claim 5, wherein the method further comprises:
a step of mounting several supports of parts to be shrink-fitted and/or several parts to be shrink-fitted on the tool; and
a step of press-fitting the set of the parts to be shrink-fitted mounted on the tool in one single activation of the actuator of the tool.
